(19) United States
(12) Patent Application Publication
(10) Pub. No.: US 2013/0285344 A1
(43) Pub. Date: Oct. 31, 2013

(54) Vehicle Suspension Transverse Link

(71) Applicant: Ford Global Technologies, LLC, Dearborn, MI (US)

(72) Inventors: Christoph Meier, Koln (DE); Theo Kueppers, Waldfeucht (DE)

(73) Assignee: Ford Global Technologies, LLC

(21) Appl. No.: 13/860,614

(22) Filed: Apr. 11, 2013

(30) Foreign Application Priority Data
Apr. 12, 2012 (DE) 102012205960.1

(51) Int. Cl. B60G 7/00

(52) U.S. Cl. CPC B60G 7/001
USPC 280/124.134

(57) ABSTRACT

A vehicle suspension transverse link, including a bearing journal assembly having a pin-shaped portion and an anchor portion that attaches to a connecting point on the link. The anchor portion has a curved configuration.

### CROSS-REFERENCE TO RELATED APPLICATIONS

This application is a continuation and claims the benefit of German Patent Application No. DE 102012205960.1 titled “Transverse link for a vehicle” filed Apr. 12, 2012, which is hereby incorporated by reference in its entirety.

### TECHNICAL FIELD

The present disclosure relates to a transverse link for a motor vehicle.

### BACKGROUND

Vehicle suspension transverse links can be subjected to dynamic loads during braking, acceleration and/or cornering maneuvers. Accordingly, the link sees relatively high stress and moments of inertia. Designs for suspension transverse links usually err on the side of heavier structural materials and more mass.

It is desirable, however, to have a less weighty suspension system that still performs reliably.

### SUMMARY

The present disclosure addresses one or more of the above-mentioned issues. Other features and/or advantages will become apparent from the description which follows.

One advantage of the present disclosure is that a more compact and space-saving design of the transverse link is provided with the present teachings. In particular, space is saved in the region of the connecting point on the body to which a pin-shaped bearing journal can be connected.

In one advantageous refinement of the present disclosure is that the bearing journal is curved in the direction of a wheel leg. In this way, the front edge of the connecting leg can be moved further rearward in the direction of the wheel leg thereby resulting in more space between the connecting leg and the vehicle body or subframe when the transverse link is installed.

One exemplary embodiment relates to a transverse link for a vehicle, including: a connecting leg configured to connect the link to a vehicle body; a wheel leg attached to the connecting leg and configured to connect the link to a wheel carrier; and a bearing journal having a curved anchoring portion secured to the connecting leg.

Another exemplary embodiment relates to a vehicle suspension transverse link, made by: (i) providing a connecting leg configured to connect the link to a vehicle body; (i) providing a wheel leg attached to the connecting leg, configured to connect the link to a wheel carrier; (iii) bending an anchor portion of a bearing journal; and (iv) attaching the anchoring portion of the bearing journal to the connecting leg.

Another exemplary embodiment relates to a vehicle suspension transverse link, having: a bearing journal assembly having a pin-shaped portion and an anchor portion that attaches to a connecting point on the link. The anchor portion has a curved configuration.

The invention will be explained in greater detail below by way of example with reference to the figures, in which the same reference numbers are used in the figures for identical or essentially identical elements. The above features and advantages and other features and advantages of the present teachings are readily apparent from the following detailed description for carrying out the invention when taken in connection with the accompanying drawings. In the figures:

### BRIEF DESCRIPTION OF THE DRAWINGS

FIG. 1 is a perspective view of a transverse link according to an exemplary embodiment of the present disclosure.

FIG. 2 is a cross-sectional view of the transverse link from FIG. 1 at circle 2.

### DETAILED DESCRIPTION

Turning now to the figures, where like characters represent the same parts, there is shown therein a transverse link for use in a vehicle suspension.

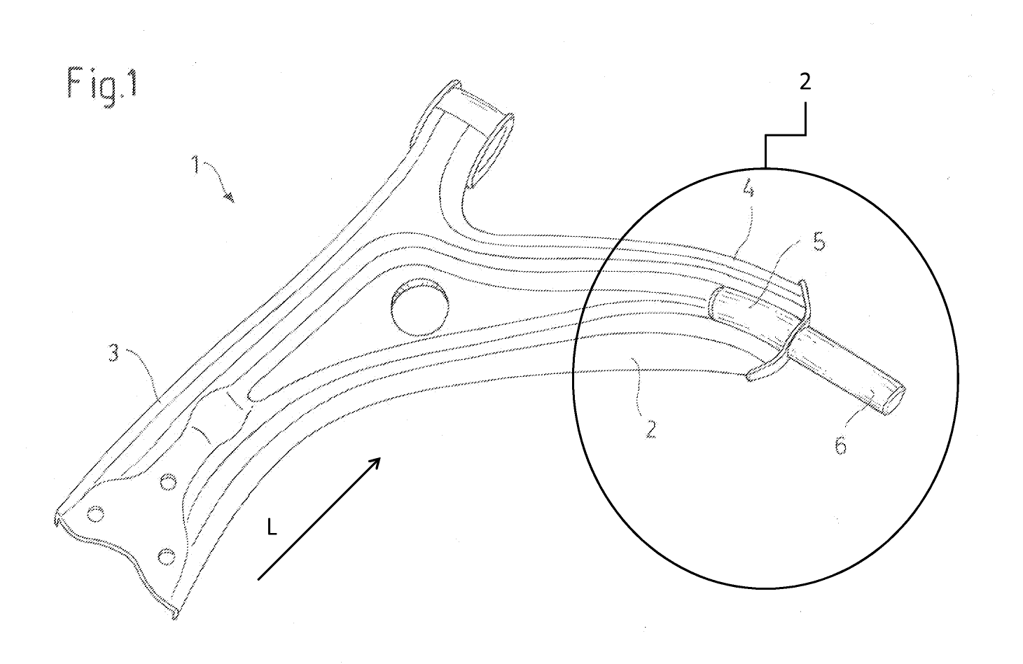

With respect to FIG. 1, there is shown therein a perspective view of an exemplary embodiment of a transverse link 1. The transverse link 1 is of single-shell form. The transverse link 1 has a connecting leg 2 for connecting to a vehicle body and has a wheel leg 3 for connecting to a wheel carrier. In this regard, the connecting leg 2 and the wheel leg 3 in the transverse link 1 form approximately an “L” shape. The connecting leg 2 has a connecting point 4 to which an anchoring portion 5 of a pin-shaped bearing journal 6 can be connected in a secure manner.

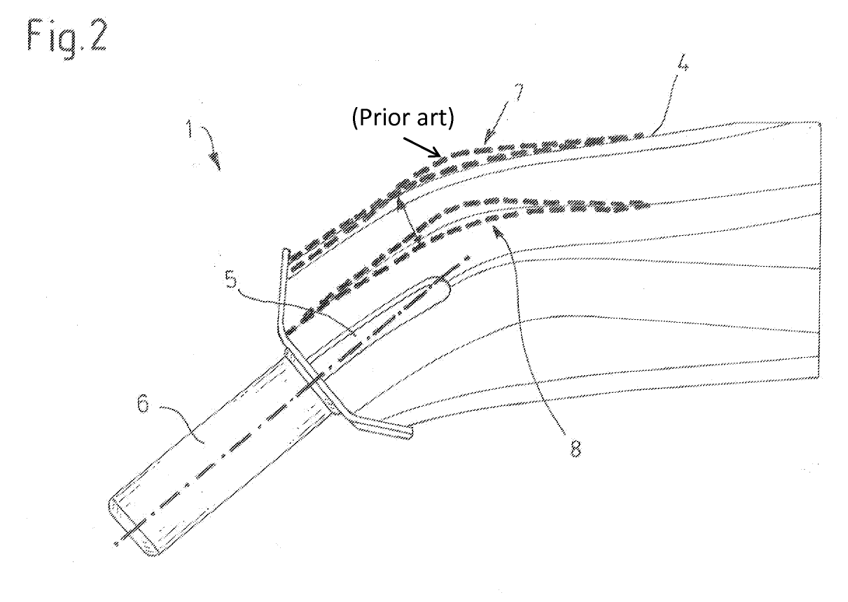

As can be seen in FIGS. 1 and 2, the connecting point 4 of the transverse link 1 at the bearing journal 6 is slightly curved in the anchoring portion 5. In particular, the anchoring portion 5 is curved in the direction of the wheel leg 3 of the transverse link 1, or in a longitudinal direction of the vehicle, L, as shown in FIG. 1. By this means, it is possible for the profile of a front edge 7 of the connecting leg 2 to be configured such that more space is available between the connecting leg 2 and the vehicle subframe when installed. Additionally, a material deformation of the transverse link programmed or encouraged to deform in the region of the connecting point 4. As can be seen from FIG. 2, the material deformations that have been realized on the transverse link 1, in particular at 8, for receiving the bearing journal 6 have considerably greater radii than in the case of a conventional transverse link according to the prior art.

As can also be seen in FIGS. 1 & 2, the connecting leg 2 is formed, at least in the region of the connecting point 4, to be a hollow profile as viewed in cross section. The hollow profile at least partially surrounds the anchoring portion 5 of the bearing journal 6 and thus provides the anchoring portion with a certain degree of additional lateral guidance and hold.

Those familiar with the art to which the invention relates will recognize various alternative designs and embodiments for practicing the invention within the scope of the appended claims.

We claim:

1. A transverse link for a vehicle, comprising:
a connecting leg configured to connect the link to a vehicle body;
a wheel leg attached to the connecting leg and configured to connect the link to a wheel carrier; and
a bearing journal having a curved anchoring portion secured to the connecting leg.

2. The transverse link of claim 1, wherein the bearing journal is curved in a longitudinal direction with respect to the vehicle.

3. The transverse link of claim 2, wherein the connecting leg includes a connecting point hollowed so as to at least partially surround the anchoring portion of the bearing journal.

4. The transverse link of claim 3, wherein the anchoring portion of the bearing journal is welded to the connecting leg.

5. The transverse link of claim 1, wherein the connecting leg includes a connecting point hollowed so as to at least partially surround the anchoring portion of the bearing journal.

6. The transverse link of claim 1, wherein the anchoring portion of the bearing journal is welded to the connecting leg.

7. A vehicle suspension transverse link, made by:
providing a connecting leg configured to connect the link to a vehicle body;
providing a wheel leg attached to the connecting leg, configured to connect the link to a wheel carrier;
bending an anchor portion of a bearing journal; and
attaching the anchoring portion of the bearing journal to the connecting leg.

8. The transverse link of claim 7, wherein the bending the anchoring point includes curving the bearing journal in a longitudinal direction of the vehicle.

9. The transverse link of claim 8, further comprising:
forming the connecting leg and wheel leg from a single piece of sheet metal.

10. The transverse link of claim 9, further comprising:
welding the bearing journal to the connecting leg.

11. The transverse link of claim 7, further comprising:
forming the connecting leg and wheel leg from a single piece of sheet metal.

12. The transverse link of claim 7, further comprising:
welding the bearing journal to the connecting leg.

13. A vehicle suspension transverse link, comprising:
a bearing journal assembly having a pin-shaped portion and an anchor portion that attaches to a connecting point on the link;
wherein the anchor portion has a curved configuration.

14. The transverse link of claim 13, wherein the bearing journal is curved in a longitudinal direction.

15. The transverse link of claim 14, wherein the connecting point is hollow.

16. The transverse link of claim 15, wherein the anchoring portion of the bearing journal is welded to the connecting leg.

17. The transverse link of claim 13, wherein the anchoring portion of the bearing journal is welded to the connecting leg.

18. The transverse link of claim 13, wherein the connecting point is hollow.

19. The transverse link of claim 13, wherein the pin-shaped portion of the bearing journal assembly is not curved.

20. The transverse link of claim 19, wherein the connecting point is hollow.
